(19) United States
(12) Patent Application Publication
(10) Pub. No.: US 2010/0170935 A1
(43) Pub. Date: Jul. 8, 2010

(54) METHOD FOR CONNECTING STRANDED WIRES IN AN ELECTRICALLY CONDUCTING MANNER AND ULTRASOUND WELDING DEVICE

(75) Inventors: Dieter Stroh, Wettenberg (DE); Heiko Stroh, Wettenberg (DE)

Correspondence Address: DENNISON, SCHULTZ & MACDONALD, 1727 KING STREET, SUITE 105, ALEXANDRIA, VA, 22314, US

(73) Assignee: SCHUNK SONOSYSTEMS GMBH, Wettenberg (DE)

(21) Appl. No.: 12/663,025

(22) PCT Filed: Jun. 4, 2008
(86) PCT No.: PCT/EP2008/056931

§ 371 Date: Jan. 4, 2010

(30) Foreign Application Priority Data
Jun. 6, 2007 (DE) 10 2007 026 707.1
Oct. 18, 2007 (DE) 10 2007 049 842.1

(51) Int. Cl. B23K 20/10; B23K 1/06

(52) U.S. Cl. 228/110.1; 228/1.1

(57) ABSTRACT

An ultrasound welding device and a method for connecting stranded wires in an electrically conducting manner with a metal U-shaped support by ultrasound welding, where the stranded wires are made of individual wires that are essentially aluminum. The sonotrode used according to the invention is a sonotrode has a welding surface which is shaped like an open trapezoid having short base sides as the bottom face during welding, the stranded wires directly contacting the bottom face and the lateral faces that extend therefrom and form an obtuse angle. The overall cross-sectional area F_{L} of the stranded wires inserted in the U-shaped support and the cross-sectional area F_{S} of the space surrounded by the bottom face and the lateral faces have a relationship F_{S}<F_{L}<2F_{S} in the welded state.

The invention relates to a method for the electrically conductive connecting of stranded conductors having conductors or single wires consisting essentially of aluminum or aluminum alloys, to a U-shaped carrier consisting of metal, by means of ultrasound welding, wherein the carrier is arranged on a backplate electrode of an ultrasound welding device, the stranded conductors are inserted into the space bounded by cross and lateral legs of the U-shaped carrier, and then welded to each other and to the carrier by means of a sonotrode excited into ultrasonic oscillation. Moreover, the invention relates to an ultrasound welding device to carry out the method, comprising a sonotrode that transmits ultrasonic vibrations with a sonotrode head having a welding surface, a backplate electrode supporting the U-shaped carrier and situated opposite the welding surface, as well as preferably side boundary elements with boundary surfaces between which the sonotrode with the welding surface extends.

When stranded conductors consisting of single wires or conductors of aluminum or aluminum material are welded together or to a massive carrier, it has been found in practice that the welding energy applied results in the aluminum flowing, i.e., passing into the so-called pasty phase, to a degree such that an alloying occurs at the sonotrode surface or at the slide which laterally bounds the compacting space that receives the stranded conductors.

To prevent this, it has been proposed to arrange intermediate foils between the tools of the ultrasound welding device and the stranded conductors consisting of aluminum, preventing a direct contact with the welding tools.

U.S. Pat. No. 3,717,842 makes use of the same notion and it relates to a method for the welding of aluminum wires with a U-shaped carrier. In order to make the welded connection, at first the carrier is crimped in familiar fashion around the aluminum wire and then the welding process is initiated. In this process, the uncrimped section of the carrier is situated between the sonotrode and the wires.

Both the inserting of an intermediate foil and the additional crimping constitute drawbacks to the method and are especially undesirable in highly automated welding sequences.

The basic problem of the present invention is to further modify a method and an ultrasound welding device of the above-described kind so that stranded conductors consisting of aluminum or containing aluminum can be welded to a massive U-shaped part without requiring intermediate foils or having to crimp the massive part in order to avoid a direct contact between the stranded conductor and the tools required for the welding.

According to the invention, the problem is basically solved, in terms of method, in that the sonotrode used is one whose welding surface has the trend of an open trapezium with short base leg as the bottom surface, and during the welding the bottom surface with the side surfaces emerging from it and subtending an obtuse angle α relative to it make direct contact with the stranded conductors, while the overall cross sectional area F_{L} of the stranded conductors placed in the U-shaped carrier in the welded state as a ratio to the cross sectional area F_{S} of the space enclosed by the bottom surface and the side surfaces of the welding surface is F_{S}<F_{L}<2F_{S}.

Surprisingly, it turns out that when a substantial part of the wires or conductors of the strands being welded are received by the space surrounded by the welding surface of the sonotrode and forming a trapezium of constant cross section, no alloying to the sonotrode surface occurs. The reason for this might be that the overall transverse forces arising during the compacting and welding of the strands are absorbed to a considerable extent by the side surfaces of the sonotrode, i.e., the sides of the sonotrode head that provide the welding surface, so that the strands present outside of the space bounded by the welding surface do not begin to alloy, regardless of the flow occurring during the welding at the regions of the sonotrode head. This also holds for the regions extending outside of the welding surface following the course of an open equilateral trapezium.

Another explanation of why an alloying does not begin inside the seat of the sonotrode head forming a trapezium in cross section might be that the largest relative movement occurs in this region, so that even if a freezing of the electrode might occur in some areas the connection is broken by the relative movement.

In particular, an alloying to the outside surfaces of the sonotrode head that extend along the side legs of the U-shaped carrier when inserted into the latter is prevented if the clear distance from the side legs of the U-shaped carrier, the width of the sonotrode or the sonotrode head, and the conductors being welded are attuned to each other in their dimensions so that when the sonotrode or the sonotrode head is inserted into the U-shaped carriers to weld the conductors to each other and to the carrier a gap of width S, with S≦½A_{D}, where A_{D} is the diameter of the respective conductors of the strand, remains between inner surface of the respective side leg of the U-shaped carrier and the outer surface of the sonotrode or sonotrode head that is facing it. If one is welding strands with conductors of different cross section, the width of the gap should be designed for the conductors of smallest diameter.

Although it is known how to weld stranded conductors generally consisting of copper to a U-shaped carrier, with the sonotrode having a welding surface at the side with the strands, having a concave trend that can be adapted to a trapezoidal geometry (DE-U-20 2004 010 775), this geometry is supposed to reduce the transverse forces arising during the welding in order to minimize a warping of the side legs of the U-shaped carrier. The dimensioning of the welding surface of the sonotrode is chosen so that the strands in the welded state have an overall cross section which is a multiple of the cross sectional area of the space bounded by the welding surface of the sonotrode. In particular, this teaching is also meant to ensure that the carrier can be welded securely to copper stranded conductors that stick out from the side legs of the carrier in the welded state.

The material for the U-shaped carrier should be at least one from the group of SE-Cu58, SF—Cu, E-Cu58, CuNi3SiMg, CuFe2P, CuCrSiTi, CuZn37, CuSn6, CuSn8. The designation of the materials corresponds to that of the DIN standard.

In particular, the material for the carrier is a cold hammered one, suitable for rather high-quality plug connectors. In this case, however, at least the surface of the carrier at the strand side should be coated with silver in particular, or a material containing silver, by galvanization, for example.

As a further modification of the invention, one uses a sonotrode having a U-shaped head segment at the strand side, bounding on its inside the welding surface with the bottom surface and the side surfaces extending at an angle α, which are inner surfaces of side legs of the head segment, and the sonotrode head has a width B and the side legs project beyond the bottom surface with a height T such that 0.15B≦T≦0.30B.

Furthermore, a sonotrode should be used in which the angle α between the bottom surface and the respective side surface is 125°≦α≦145°.

The space receiving the strands and surrounded by the welding surface of the sonotrode is bounded by side legs or webs, whose end face runs parallel to the bottom surface. The width of the respective end face should be between 0.25 mm and 1.5 mm. This dimensioning likewise ensures that no alloying of the aluminum takes place during the welding.

The sonotrode or the sonotrode head which is inserted into the U-shaped carrier, i.e., the massive part, can have a width B between 1 mm and 25 mm.

An ultrasound welding device of the kind mentioned in the beginning is characterized in that the welding surface has the trend of an open equilateral trapezium with bottom surface and side surfaces, the bottom surface and the respective side surface subtend an angle α with 125°≦α≦145°, the side surfaces are inner surfaces of legs of the sonotrode head projecting by a height T above the bottom surface and bounding the sonotrode head at the sides, and the sonotrode head has a width B, which stands in a ratio to the height T of the space surrounded by the welding surface as 0.15B≦T≦0.30B.

The legs of the sonotrode head have end faces which run parallel to the bottom surface of the welding surface and have a width A with 0.25 mm≦A≦1.5 mm.

Moreover, the sonotrode head which is inserted into the U-shaped carrier can have a width B with 1 mm≦B≦25 mm.

In particular, the U-shaped carrier consists of at least a material of the group SE-Cu58, SF—Cu, E-Cu58, CuNi3SiMg, CuFe2P, CuCrSiTi, CuZn37, CuSn6, CuSn8.

If the U-shaped carrier consists of a cold hammered material like CuCrSiTi, this should preferably be coated with silver and a silver-containing material at least on the strand side.

In order to ensure a definite positioning of the carrier during the compacting and welding of the stranded conductors, the respective lateral boundary element has a recess at the carrier side, which is adapted to the height and width of the side leg so as to accommodate this during the ultrasound welding.

Further details, benefits and features of the invention will appear not only from the claims, the features found in them—in themselves or in combination—but also from the following description of preferred sample embodiments taken from the drawing.

There are shown:

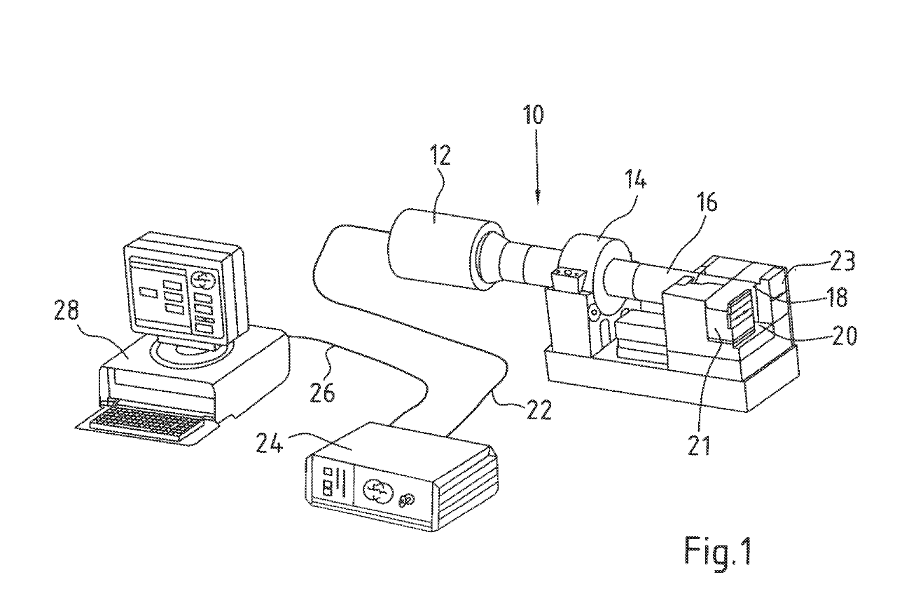

FIG. 1, an arrangement of an ultrasound welding layout in principal diagram,

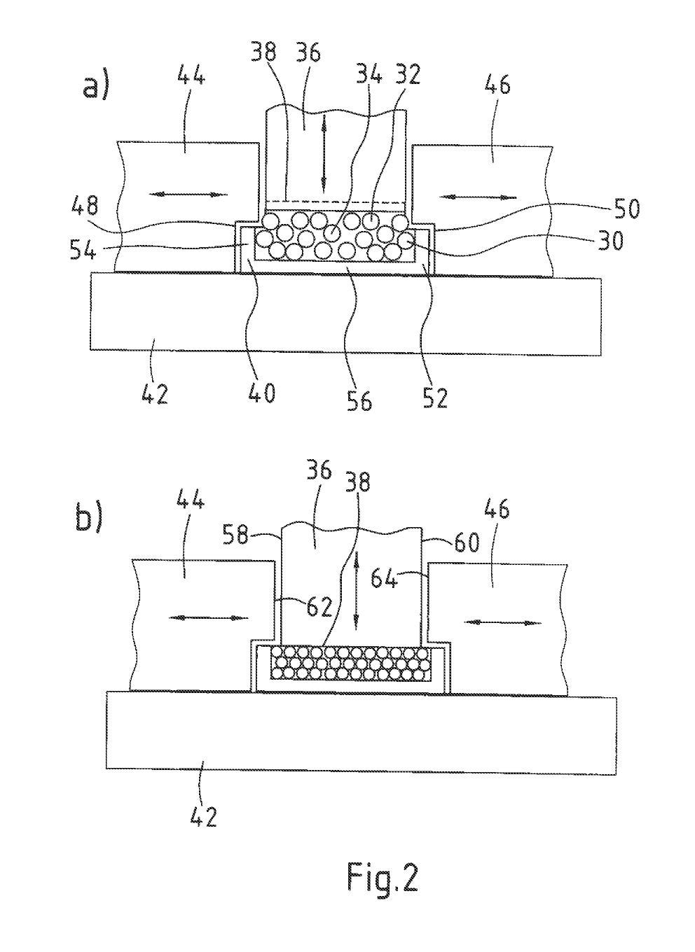

FIG. 2a, b, principal diagrams of the compacting and welding of aluminum stranded conductors to a U-shaped carrier according to the prior art,

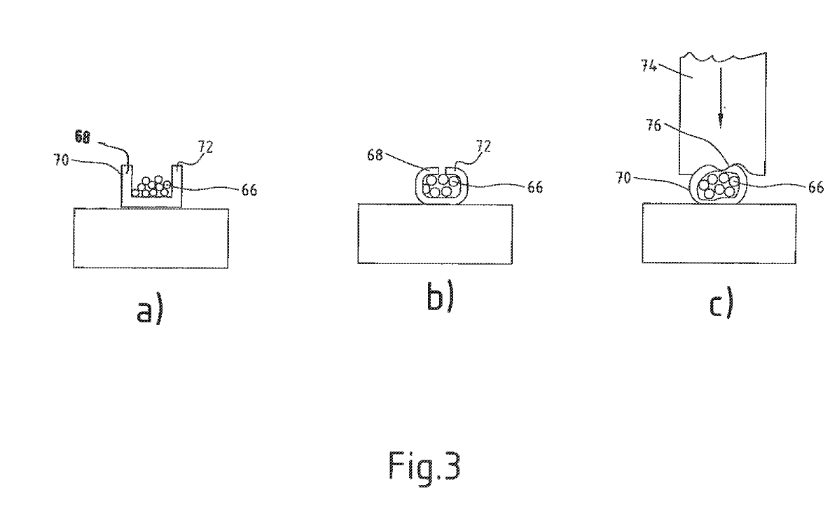

FIGS. 3a-3c, in a principal diagram, a crimping and welding process according to the prior art,

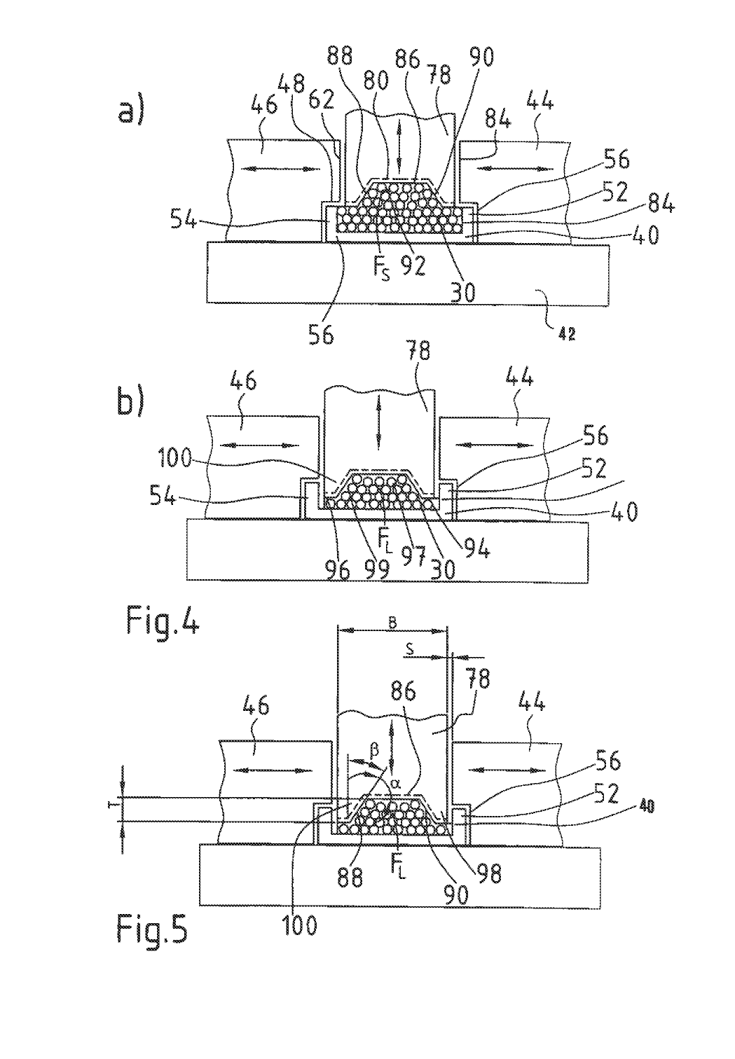

FIGS. 4a, 4b, in a principal diagram, the compacting and welding of aluminum stranded conductors to a U-shaped carrier according to the invention, and

FIG. 5, another principal diagram of a sonotrode to be used according to the invention.

FIG. 1 shows a principal diagram of an ultrasound welding layout, in which stranded conductors consisting of aluminum or containing aluminum, i.e., their fine wires or conductors, can be welded to a punching/bending part in the form of a U-shaped massive carrier made of metal. The layout comprises an ultrasound welding device or machine 10, which usually has a converter 12, possibly a booster 14, and also a sonotrode 16. The sonotrode 16, i.e., its head 18 and thus its welding surface, are coordinated with a backplate electrode 20—also known as an anvil—and side slides 21, 23, in order to enclose a compacting space.

The converter 12 is connected by a line 22 to a generator 24, which in turn leads via a line 26 to a computer 28, by which a control of the welding process is carried out, and where the welding parameters or cross section and materials of the strands and carriers being welded can be entered or corresponding memorized values can be retrieved.

According to the prior art (FIGS. 2a, 2b, FIG. 3a, b, c), strands 30 consisting of aluminum, which consist of individual thin wires or conductors 32, 34, are welded by means of a sonotrode 36, which has a planar welding surface 38. Desired structures such as corrugations, pyramids or the like can be fashioned in the welding surface 38. To prevent an alloying of the strands 30, i.e., their wires 32, 34, to the sonotrode 36 or its welding surface 38, the prior art calls for placing a foil on the strands 30, thereby avoiding a direct contact between the conductors 32, 34 and the welding surface 38.

If no such intermediate foils are used, an alloying occurs with the aluminum, which becomes pasty due to the ultrasound vibrations applied to it and consequently flows. This is evident from a comparison of FIGS. 2a and 2b. Thus, a U-shaped carrier 40 with the strands 30 being welded is arranged on an anvil 42 of an ultrasound welding machine, as can be seen in the principal diagram of FIG. 1. At the sides of the carrier 40 are arranged movable side slides 44, 46, being oriented to the carrier 40 such that it is contained in steplike recesses 48, 50 with side legs 52, 54, joined by a cross leg 56, which is placed on the anvil 42.

A compacting and welding now occurs by lowering the sonotrode 36 and exciting it so that the aluminum material of the strands 30 flows, with the result that this material not only alloys to the welding surface 38, but also gets into the gap between the sonotrode's side surfaces 58, 60 and the facing boundary surfaces 62, 64 of the side slides 44, 46, and from here it can also alloy to both the surfaces 62, 64 of the side slides 44, 46 and to the outer surfaces 58, 60 of the sonotrode 36.

To prevent such alloying, U.S. Pat. No. 3,717,842 proposes placing stranded conductors 66 consisting of aluminum in a U-shaped carrier 68, whose side legs 70, 72 are dimensioned so that they can be crimped around the strands 66 in the beginning (FIG. 3b) and then, when the sonotrode 74 is lowered, by means of which the welding of the strands 66, i.e., their thin wires, to the crimped carrier 70 occurs, whose welding surface 76 does not come into direct contact with the strands 66 or their wires. Thus, in theory, a technical solution is realized, such as was already realized with the intermediate foil according to the explanations in FIGS. 2a and 2b.

However, the crimping or use of intermediate foil has drawbacks, especially for highly automated welding processes carried out in production sequences, since not only do they produce sources of faults, but also slow down and thereby increase the cost of production.

To obviate these drawbacks, the teaching of the invention according to the principal diagram of FIGS. 4a, 4b, 5, which use essentially the same reference elements for identical elements as in FIGS. 2a, 2b, proposes configuring a sonotrode 78 of a conventional ultrasound welding machine in its welding surface 80 so that the transverse forces arising during the welding and promoting the alloying are absorbed to a considerable extent by the sonotrode 78, so that surprisingly no alloying occurs.

According to the diagram of FIGS. 2a, 2b, the U-shaped carrier 40 with the side legs 52, 54 and the cross leg 56 is positioned on the anvil 42. Then the side slides 44, 46 are brought up against the carrier 52, whereby the cross legs 52, 54 are received by virtue of the steplike recess 48, 50 in the side boundary surfaces 62, 64, so that the boundary surfaces 62, 64 outside of the steps 48, 50 are nearly flush with the inner surfaces 82, 84 of the side legs 52, 54 of the U-shaped carrier 40.

The sonotrode 78 or its head inserted into the carrier 40 has a welding surface 80 according to the invention which exhibits the shape of an open equilateral trapezium with shorter bottom surface 86 and side surfaces 88, 90, the respective side surface 88, 90 subtending an angle α or β+90° with the bottom surface 86 that amounts to 125°≦α≦145°. Moreover, the welding surface 80 has a depth T such that the space 92 bounded by the side surfaces 88, 90 and the bottom surface 86 has a cross section which is greater than the half cross section F_{L} of the strands 30, i.e., the conductors 32, 34 in the welded state, which is shown by principal diagram in FIG. 4b. Consequently, the cross sectional area 97 of the welded conductors 32, 34 having a trapezoidal shape is larger than the lower rectangular cross sectional area 99, i.e., the area extending between the end faces 94, 96 of the legs 98, 100 of the sonotrode head and the bottom surface of the cross leg 56 of the carrier 40.

Thus, the sonotrode head has a U-geometry in the region of the welding surface 80, whose opening is turned toward the stranded conductors 30.

Thanks to the teaching and the indicated dimensions of the invention, the transverse forces acting overall on the strands 30 and caused by the lowering of the sonotrode 78 and when the sonotrode 78 is ultrasound-excited are considerably reduced, with the result that the fluid aluminum material, being a pasty phase, is not prone to alloying to the welding surface 80 or to the end faces 94, 96 of the legs 98, 100, bounding the space 92 enclosed by the bottom surface 86 and the side surfaces 88, 90 of the welding surface 80. Consequently, the inner surfaces of the legs or webs 98, 100 of the sonotrode head are the side surfaces 88, 90 of the welding surface 80.

The absence of an alloying of the aluminum to the welding surface 80 may also be explained in that the greatest relative movement between the conductors 32, 34 and the welding surface 80 occurs in this region, so that even if a momentary alloying should occur, it will be disrupted by virtue of the relative movement.

A flowing of the aluminum into the gap S between the outer surface of the sonotrode 78 or its head and the lateral boundary surfaces 62, 64 of the side slides 46, 48 is further hindered in that the clear distance from the inner surfaces 82, 84 of the U-shaped carrier 40, i.e., its side legs 52, 54, the width B of the sonotrode and consequently also the spacing of the side slides 46, 48 are attuned to each other such that a gap width S results that is less than half the diameter A_{D} of the particular conductors 32, 34 being welded. If one is welding strands 30 with conductors of different cross section, the gap S should be attuned to the diameter of the conductors of smallest cross section. The conductors 34, 36 can have diameters in the range of 0.1 mm to 1 mm.

The height T of the space enclosed by the welding surface 80, i.e., the height of the legs 98, 100 projecting above the bottom surface 86 should stand in a ratio to the width B of the sonotrode 78 or the sonotrode head as 0.15B≦T≦0.30B. The width of the sonotrode head which is inserted into the U-shaped carrier 40 is preferably in the range between 1 mm and 25 mm.

Furthermore, the end face 94, 96 of the respective leg 98, 100 should have a width spacing between the side legs 52, 54 of the U-shaped carrier in the range between 0.25 mm and 1.5 mm. This dimensioning will further ensure that no alloying of the aluminum occurs.

As material for the carrier 40, one should select one of the following group: SE-Cu58, SF—Cu, E-Cu58, CuNi3SiMg, CuFe2P, CuCrSiTi, CuZn37, CuSn6, CuSn8. The designations of the materials correspond to the DIN standard.

For high-quality connections, U-shaped carriers of cold hammered steel, such as CuCrSiTi, are normally used.

In order to ensure an intimate material connection in view of the different hardness of aluminum and the carrier material, preferably the inner surface of the carrier should be coated with silver preferably, or a material containing silver, by galvanization, for example.

Furthermore, the configuration of the sonotrode 78 according to the invention and the specified height T of the space enclosed by the welding surface 80 provide the advantage that the sonotrode 78 is inserted to a considerable extent into the U-shaped carrier 40, so that as a consequence the transverse forces acting on the side legs 52, 54 of the carrier 40 are reduced with the result that a softer material than in the prior art can be used as base material for the carrier 40. The U-shape makes the carrier 40 much more stiff to bending.

1. Method for the electrically conductive connecting of stranded conductors (30) having conductors or single wires (32, 34) consisting essentially of aluminum or aluminum alloys, to a U-shaped carrier (40) consisting of metal, by means of ultrasound welding, wherein the carrier is arranged on a backplate electrode (42) of an ultrasound welding device (10), the stranded conductors are inserted into the space bounded by cross and lateral legs (52, 54, 56) of the U-shaped carrier, and then welded to each other and to the carrier by means of a sonotrode (16, 78) excited into ultrasonic oscillation, characterized in that the sonotrode (16, 78) used is one whose welding surface (80) has the trend of an open trapezium with short base leg as the bottom surface (86), and during the welding the bottom surface with the side surfaces (88, 90) emerging from it and subtending an obtuse angle α relative to it make direct contact with the stranded conductors (30), while the overall cross sectional area F_{L} of the stranded conductors placed in the U-shaped carrier (40) in the welded state as a ratio to the cross sectional area F_{S} of the space enclosed by the bottom surface and the side surfaces of the welding surface is F_{S}<F_{L}<2F_{S}.

2. Method according to claim 1, characterized in that the clear distance from the side legs (52, 54) of the U-shaped carrier (40), the width of the sonotrode (78), and the conductors (32, 34) being welded are attuned to each other in their dimensions so that when the sonotrode is inserted into the U-shaped carriers to weld the conductors to each other and to the carrier a gap of width S, with S≦½A_{D}, where A_{D} is the diameter of the respective conductors of the strand, remains between the respective inner surface of the side leg of the U-shaped carrier and the outer surface of the sonotrode that is facing it.

3. Method according to claim 1 or 2, characterized in that when one is welding strands (30) with conductors (32, 34) of different cross section, the width S of the gap is designed for the conductors of smallest diameter.

4. Method according to at least one of the preceding claims, characterized in that the material for the U-shaped carrier (40) is at least one from the group of SE-Cu58, SF—Cu, E-Cu58, CuNi3SiMg, CuFe2P, CuCrSiTi, CuZn37, CuSn6, CuSn8.

5. Method according to at least one of the preceding claims, characterized in that the material for the U-shaped carrier (40) is a cold hammered material, which is coated at the conductor side.

6. Method according to at least one of the preceding claims, characterized in that the carrier (40) at the conductor side is coated with silver or a material containing silver, preferably by galvanization.

7. Method according to at least one of the preceding claims, characterized in that a sonotrode (778) is used, having a U-shaped head segment at the conductor side, bounding on its inside the welding surface (80) with the bottom surface (86) and the side surfaces (88, 90) extending at an angle α, which are inner surfaces of side legs (98, 100) of the head segment, and the sonotrode has a width B and the side legs project beyond the bottom surface by a length T such that 0.15B≦T≦0.30B.

8. Method according to at least one of the preceding claims, characterized in that a sonotrode (78) is used in which the angle α between the bottom surface (86) and the respective side surface (88, 90) is 125°≦α≦145°.

9. Method according to at least one of the preceding claims, characterized in that a sonotrode (78) is used with side legs (98, 100), whose end faces (94, 96) run parallel to the bottom surface (80), and the width A of the respective end face is 0.25 mm≦A≦1.5 mm.

10. Method according to at least one of the preceding claims, characterized in that a sonotrode (78) is used with width B with 1 mm≦B≦25 mm.

11. Ultrasound welding device (10) to carry out the method of claim 1, comprising a sonotrode (16, 78) that transmits ultrasonic vibrations with a sonotrode head having a welding surface (80), a backplate electrode (42) supporting the U-shaped carrier (40) and situated opposite the welding surface, as well as preferably side boundary elements (46, 48) with boundary surfaces (62, 64),
characterized in that the welding surface (80) has the trend of an open equilateral trapezium with bottom surface (86) and side surfaces (88, 90), the bottom surface and the respective side surface subtend an angle α with 125°≦α≦145°, the side surfaces are inner surfaces of legs (98, 100) of the sonotrode (78) or sonotrode head projecting by a height T above the bottom surface and bounding the sonotrode head at the sides, and the sonotrode head has a width B, which stands in a ratio to the height T as 0.15B≦T≦0.30B.

12. Ultrasound welding device according to claim 11, characterized in that the U-shaped carrier (40) consists of at least a material of the group SE-Cu58, SF—Cu, E-Cu58, CuNi3SiMg, CuFe2P, CuCrSiTi, CuZn37, CuSn6, CuSn8.

13. Ultrasound welding device according to claim 11 or 12, characterized in that the U-shaped carrier (40) consists of a cold hammered material which is preferably coated with silver or a silver-containing material at least on the strand side.

14. Ultrasound welding device according to one of claim 11 to 13, characterized in that the legs (98, 100) of the sonotrode head (78) have end faces (94, 96) which run parallel to the bottom surface (86) of the welding surface (80) and have a width A with 0.25 mm≦A≦1.5 mm.

15. Ultrasound welding device according to one of claim 11 to 14, characterized in that the sonotrode head (78) which is inserted into the U-shaped carrier (40) has width B with 1 mm≦B≦25 mm.

16. Ultrasound welding device according to one of claim 11 to 15, characterized in that the respective lateral boundary element (46, 48) has a recess (48, 50) at the carrier side, which is adapted to the height and width of the side leg (52, 54) of the U-shaped carrier (40) so as to accommodate the leg during the ultrasound welding.
